(19) United States
(12) Patent Application Publication
(10) Pub. No.: US 2026/0234030 A1
(43) Pub. Date: Aug. 13, 2026

(54) HYDROGEN PRODUCTION FROM WASTEWATER

(71) Applicant: Saudi Arabian Oil Company, Dhahran (SA)

(72) Inventors: Rakesh Kumar, Al Khobar (SA); Mohammad Abdur Rakib, Dhahran (SA); Salman Khaldi, Dammam (SA)

(21) Appl. No.: 19/051,468

(22) Filed: Feb. 12, 2025

(51) Int. Cl. C02F 1/02; B01D 53/22; B01D 61/02; C01B 3/38; C01B 3/48; C01B 3/50; C02F 1/44; C02F 101/10; C02F 101/12; C02F 101/32; C02F 103/36

(52) U.S. Cl. CPC C02F 1/02; B01D 53/22; B01D 61/025; C01B 3/38; C01B 3/48; C01B 3/501; C02F 1/441; B01D 2256/16; B01D 2257/504; B01D 2257/80; C01B 2203/0233; C01B 2203/0283; C01B 2203/041; C01B 2203/0475; C01B 2203/0495; C02F 2101/101; C02F 2101/108; C02F 2101/12; C02F 2101/32; C02F 2103/365; C02F 2301/066; C02F 2303/10

(57) ABSTRACT

A method of producing hydrogen (H₂) and clean water from a wastewater stream. The method includes pressurizing a wastewater stream including organic and inorganic contaminants, and heating the wastewater stream to a first temperature. The method further includes feeding the pressurized and heated wastewater stream to a salt separator to separate the inorganic contaminants from the pressurized and heated wastewater stream, generating a salt-free wastewater stream. The method further includes heating the salt-free wastewater stream to a second temperature, and converting the salt-free wastewater stream at the second temperature into a methane-containing gasification product under a sub- or supercritical condition using a first reactor, the methane being formed from the organic contaminants. The method further includes reforming the methane-containing gasification product using a second reactor including a reforming catalyst to produce a product stream including H₂, carbon dioxide (CO₂), and water vapor.

### TECHNICAL FIELD

This disclosure relates to methods and systems for hydrogen production from wastewater.

### BACKGROUND

Many industrial processes produce wastewater contaminated with organic and inorganic components and treating the wastewater for their removal can be an energy intensive process. For example, a dilute wastewater stream generated from refining and petrochemical sectors is often contaminated with different fractions of hydrocarbons and petroleum fractions, e.g., diesel, gasoline, and kerosene. Effective handling of such a dilute oily wastewater stream with different fractions is a complex task. Conventional methods have drawbacks such as high cost, use of toxic compounds, large space for installation and generation of secondary pollutants. Accordingly, a novel, efficient process for wastewater stream may be desired to address these issues.

### SUMMARY

This disclosure describes technologies relating to novel step-wise wastewater treatment that can produce clean water and hydrogen (H₂). The wastewater treatment process of this disclosure can combine salt separation, hydrothermal gasification under sub- or supercritical condition, and methane reforming to produce H₂ and carbon dioxide (CO₂). In some implementations, the reforming can be performed using a H₂-selective membrane reactor to isolate H₂ as a permeate, eliminating a separate H₂ separation unit and allowing a low temperature reforming process. Further, the reactor system of the wastewater treatment can be designed to produce a syngas. In some implementations, reverse osmosis can be incorporated as pretreatment in the process to concentrate contaminants in the wastewater. The technology described herein can offer an attractive alternative method of treating wastewater over conventional methods by producing a valuable fuel gas and clean water.

### BRIEF DESCRIPTION OF DRAWINGS

FIG. 1 is a schematic illustration of a step-wise wastewater treatment system having a H₂-selective membrane reactor.

FIG. 2 is a schematic illustration of a supercritical salt separator for a step-wise wastewater treatment system.

FIG. 3 is a schematic illustration of a H₂-selective membrane reactor for a step-wise wastewater treatment system.

FIG. 4 is a schematic illustration of a step-wise wastewater treatment system for syngas production.

FIG. 5 is an example process flow diagram of methods of H₂ production using a step-wise wastewater treatment system.

FIG. 6 is an example process of wastewater treatment for ASPEN Plus® simulation.

### DETAILED DESCRIPTION

Generally, wastewater treatment by thermochemical route such as hydrothermal liquefaction, catalytic hydrothermal gasification of wet organics under subcritical and supercritical conditions to liquid and H₂ and methane (CH₄) rich gaseous product is becoming more attractive compared to conventional methods such as pyrolysis or hydro-pyrolysis due to higher energy efficiency. The hydrothermal route can eliminate energy intensive drying of wet organics waste. Further, sub- or supercritical water gasification process provides certain advantages over conventional gasification, including but not limited to high reaction rate, elimination of mass transfer limitation, better heat transfer characteristics, and less solid residue. Water exhibits distinct thermal and physical properties that changes drastically when temperature and pressure approach supercritical condition (above T=374° C., P=22.1 MPa). For example, dielectric constant of water drops from a very high value, e.g., 80 at 25° C., to about 2.0 at 450° C. and 30 MPa. Under sub- or supercritical conditions, water also starts to behave like a nonpolar solvent, which can increase in solubility of organic molecules. Density of water also significantly reduces to 255.7 kg/m₃ at 450° C. and 30 MPa. Further, viscosity also decreases that leads to further increment in diffusion coefficient and enhanced mass transfer.

Accordingly, the use of sub- or supercritical water gasification (SCWG) can be an effective approach for oily wastewater treatment, where organic matter can be converted into H₂/CH₄ rich fuel gas.

Oil wastewater contains various polar organic and inorganic components in large amount of water. Catalytic hydrothermal gasification of dilute aqueous require high energy, high catalyst loading, large process equipment due to presence of large amount of water. Considering the amount of hydrocarbon present in an aqueous stream of industrial waste, a novel treatment process may be desired to efficiently transform these soluble components to valuable chemical products such as H₂. However, challenges remain due to very low concentration of hydrocarbon in waste stream generated from different industrial process.

Implementations described herein provide methods and systems for wastewater treatment that produce H₂. Specifically, a novel step-wise wastewater treatment of this disclosure can address challenges of treating industrial dilute wastewater contaminated with various hydrocarbons and inorganic compounds from refinery and/or other petroleum processes. The process combines salt separation, hydrothermal gasification under sub- or supercritical condition, and methane reforming to produce H₂ and carbon dioxide (CO₂), along with clean water that can be recycled and reused. In various implementations, the wastewater treatment can offer advantages over conventional methods with reduced process cost, elimination of toxic compounds, reduced equipment footprint, and not producing secondary pollutants. Importantly, the process can produce H₂. In various implementations, H₂ is produced during the first step of hydrothermal gasification under sub- or supercritical condition, and the H₂ yield can be further enhanced by the second step of methane reforming, e.g., steam methane reforming. H₂ is a promising clean energy carrier that can reduce greenhouse gas emissions and serves as a feedstock for chemical processes and can fuel decarbonization efforts in industrial assets and power generation.

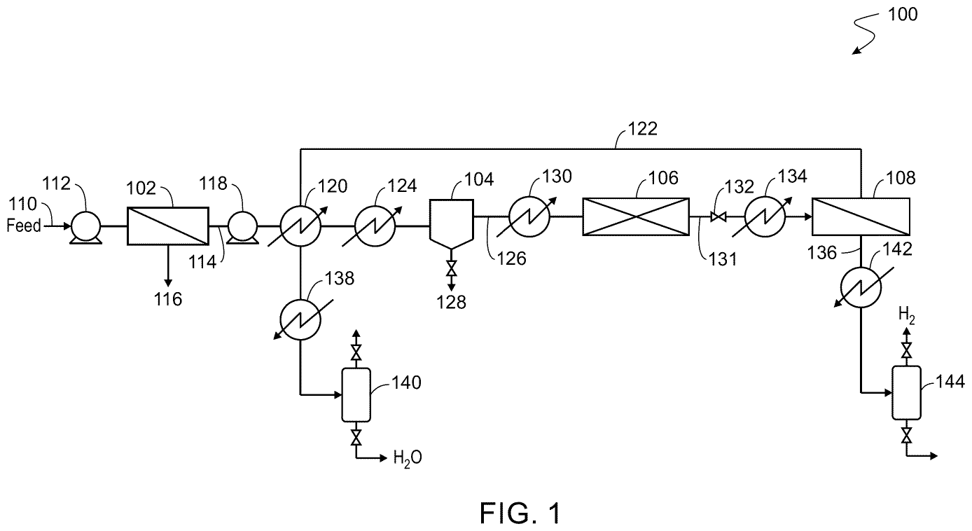

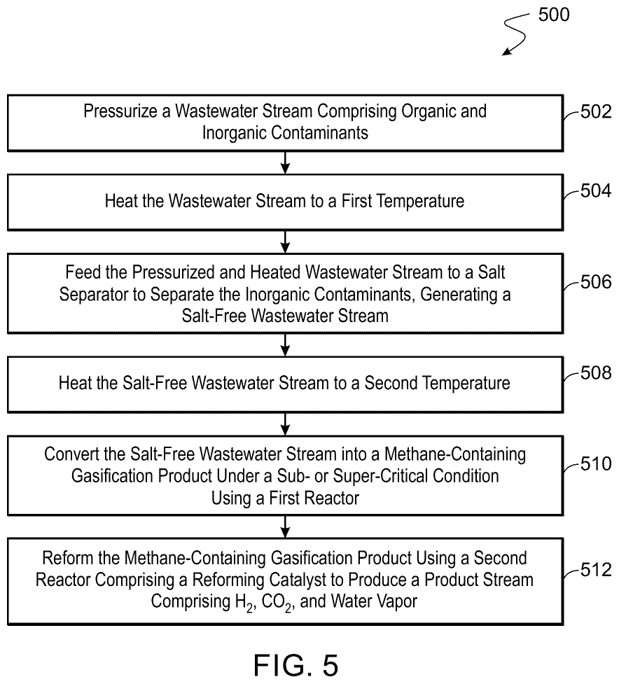

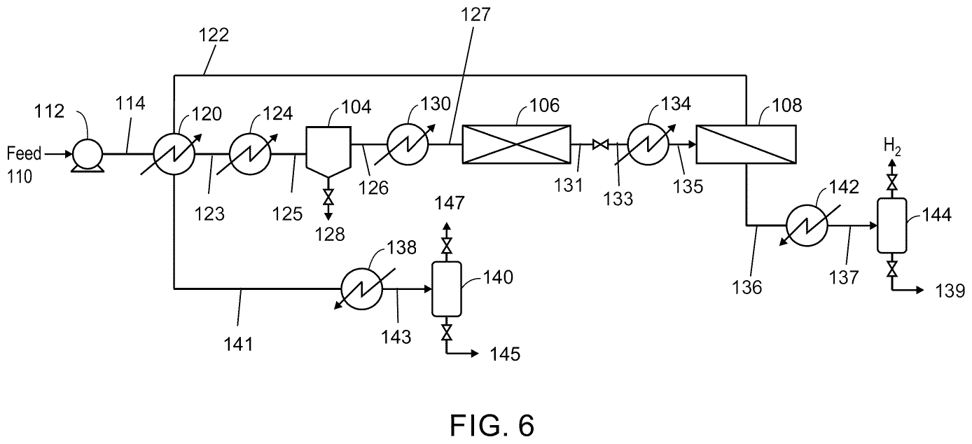

In the following, various implementations of the step-wise wastewater treatment system and their components are described referring to FIG. 1-4. An example process flow of wastewater treatment using this system is described referring to FIG. 5. FIG. 6 shows an example process of wastewater treatment for ASPEN Plus® simulation.

In FIG. 1, a wastewater treatment system 100 includes components such as a reverse osmosis (RO) unit 102 for contaminant concentration, a salt separator 104, a first reactor 106 for hydrothermal gasification, and a second reactor 108 for methane reforming to improve H₂ yield. As further described below, the wastewater treatment system 100 can include various other components such as pumps, heaters, and gas-liquid separation units are present to adjust the process condition for each process step.

As illustrated in FIG. 1, a wastewater stream 110 can be used as a feed for the process. The wastewater stream 110 can originate from oil refinery or other petroleum processes, and contain various organic and inorganic contaminants. In various implementations, the wastewater stream 110 is an oily wastewater containing aromatic hydrocarbons, e.g., benzene, toluene, ethylbenzene, xylene (BTEX), naphthalene, phenanthrene, dibenzothiophene (NPD), polycyclic aromatic compounds (PAH). Examples of other organic contaminants include aliphatic hydrocarbons, fatty acids, oil, grease, and polar organic compounds such as methanol, ethanol, acetic acid, and propanoic acid. In some implementations, the oil and grease concentrations of the wastewater stream 110 is from about 1 mg/L to about 700 mg/L, e.g., from about 10 mg/L to about 700 mg/L, from about 100 mg/L to about 700 mg/L, from about 300 mg/L to about 700 mg/L, from about 500 mg/L to about 700 mg/L, from about 1 mg/L to about 500 mg/L, from about 2 mg/L to about 565 mg/L; from about 1 mg/L to about 300 mg/L, from about 1 mg/L to about 100 mg/L, or from about 1 mg/L to about 10 mg/L. Examples of inorganic contaminants include sodium (Na⁺), potassium (K⁺), magnesium (Mg²⁺), chlorine (Cl⁻), sulfate (SO₄²⁻), carbonate (CO₃²⁻), silicate (H₄SiO₂), borate (H₃BO₃). In some implementations, the salt concentrations of the wastewater stream 110 is from about 1 mg/L to about 300,000 mg/L, e.g., from about 10 mg/L to about 300,000 mg/L, from about 100 mg/L to about 300,000 mg/L, from about 1,000 mg/L to about 300,000 mg/L, from about 10,000 mg/L to about 300,000 mg/L, from about 100,000 mg/L to about 300,000 mg/L, from about 1 mg/L to about 100,000 mg/L, from about 1 mg/L to about 10,000 mg/L, from about 1 mg/L to about 1,000 mg/L, from about 1 mg/L to about 100 mg/L, or from about 1 mg/L to about 10 mg/L.

In various implementations, the first step of the wastewater treatment is to concentrate the organic and inorganic contaminants using reserve osmosis (RO). Accordingly, the wastewater stream 110 can be first pressurized by a high-pressure pump 112 from ambient condition and fed to the RO unit 102. In some implementations, the wastewater system 110 is pressurized to a pressure from about 0.2 MPa to about 0.6 MPa, e.g., from about 0.3 MPa to about 0.6 MPa, from about 0.4 MPa to about 0.6 MPa, from about 0.5 MPa to about 0.6 MPa, from about 0.2 MPa to about 0.5 MPa, from about 0.2 MPa to about 0.4 MPa, or from about 0.2 MPa to about 0.3 MPa.

The RO unit 102 can be based on a selective membrane designed to retain the organic and inorganic components in a wastewater retentate 114 while allowing purified water to pass though the membrane as a permeate 116. In some implementations, the RO membrane is made of polyamide and other polymeric materials. The membrane can have a different type of plug flow (PF) module such as hollow fiber, spiral wound, or plate tube. The permeate 116 can be recovered as fresh water and used for various applications. In some implementations, the recovered water from the permeate 116 is used as a cooling fluid to one or more stages of the wastewater treatment system 100. In some implementations, the organic contaminants can be concentrated up to 30 wt. % in the wastewater retentate 114. Since the organic contaminants can be the source of fuel products, concentrating the organic contaminants prior to hydrothermal gasification can help improving the process economy.

The wastewater retentate 114 can be pressurized further by a high-pressure pump 118 to a pressure above 20 MPa and preheated by a preheater 120. In some implementations, as illustrated in FIG. 1, the preheater 120 is a shell and tube heat exchanger to enable heat exchange with a retentate product stream 122 sent from the second reactor 108. Such implementations allow recover heat from the second reactor 108 operated at an elevated temperature, e.g., about 550° C., and use it to preheat the wastewater retentate 114.

In various implementations, the wastewater retentate 114 after the preheating is further heated to a process temperature for the salt separation. For example, the process temperature can be above 350° C., e.g., from about 350° C. to about 400° C., from about 360° C. to about 400° C., from about 370° C. to about 400° C., from about 380° C. to about 400° C., from about 390° C. to about 400° C., from about 350° C. to about 390° C., from about 350° C. to about 380° C., from about 350° C. to about 370° C., or from about 350° C. to about 360° C.

The inorganic contaminants in the wastewater retentate 114 can be removed using the salt separator 104 to generate a salt-free wastewater 126 and a brine effluent 128. In various implementations, all or most of the inorganic contaminants are removed from the main wastewater stream, and the salt-free wastewater 126 is substantially free from salts or other inorganic contaminants. In some implementations, the residual amount of the inorganic contaminants in the salt-free wastewater 126 is less than 100 ppm, e.g., less than 10 ppm, or less than 1 ppm.

In various implementations, the salt separator 104 can be a supercritical salt separator that can be operated under sub- or supercritical condition. Nonpolar nature of supercritical water can decrease salt solubility, which helps precipitating salt from the solution.

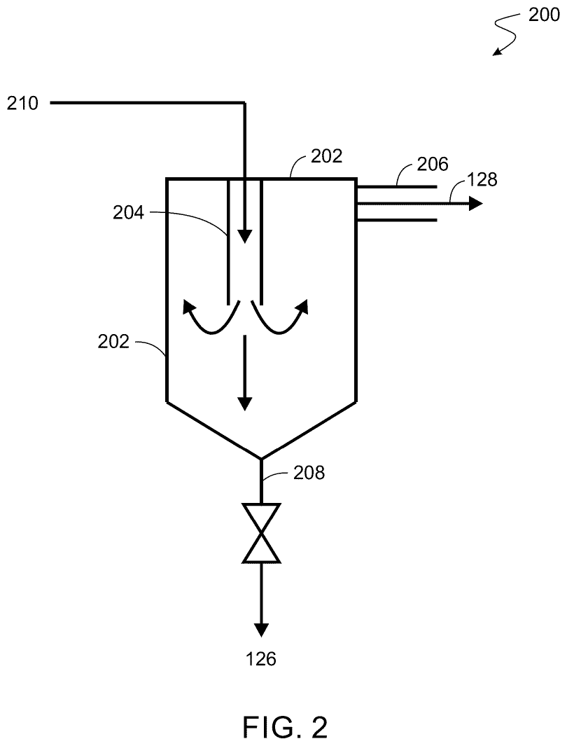

FIG. 2 illustrates a simplified schematic of a supercritical salt separator 200 that can be used in the wastewater treatment system 100. As illustrated in FIG. 2, the supercritical salt separator 200 has a reverse flow vessel 202, where an inlet 204 and a first outlet 206 is positioned at or near the top of the reverse flow vessel 202. A second outlet 208 can be positioned at or near the bottom of the vessel. A feed 210, e.g., the wastewater retentate 114 after heating and pressurizing in FIG. 1, can be introduced into the reverse flow vessel 202 via the inlet 204 under sub- or supercritical condition, e.g., temperature above 370° C. and pressure above 25 MPa. In this “hot” region of the vessel, generally an upper portion of the vessel, the salt solubility decreases sharply as the fluid reaches supercritical temperature and thus the salt particles start precipitating. The majority of the fluid can be directed to the first outlet 206 to be ejected and sent to a next component of the system. In subcritical, “cold” region, generally a lower portion of the vessel, the solubility of the salt becomes high again, and therefore the precipitated solid resolubilizes to form a brine effluent 128.

Referring back to FIG. 1, the salt-free wastewater 126 can be heated further using a heater 130 to a process temperature for hydrothermal gasification in the first reactor 106. In various implementations, the process temperature is from about 400° C. to about 550° C., e.g., from about 450° C. to about 550° C., from about 500° C. to about 550° C., from about 400° C. to about 500° C., or from about 400° C. to about 450° C. The first reactor 106 can be designed as a fixed bed, supercritical water gasification reactor to enable processes under sub- or supercritical condition. In some implementations, the first reactor 106 is charged with a heterogenous catalyst for gasification. The organic contaminants can be converted to a supercritical water gasification (SCWG) product gas 131 containing methane (CH₄) and H₂ in presence of the heterogenous catalyst in the first reactor 106. Examples of the heterogeneous catalyst for this stage include a metal component such as ruthenium (Ru), rhodium (Rh), nickel (Ni), cobalt (Co), and iron (Fe). In some implementations, the catalytic component can be supported on a support material such as alumina or other oxide or nitride materials. In some implementations, despite the naming of the SCWG product gas 131, the gasification can be performed slightly below the supercritical condition, e.g., a subcritical condition.

The pressure energy of the SCWG product gas 131 can be recovered by a pressure recovery turbine 132 and used for powering various components of the wastewater treatment system 100. This energy integration helps the overall process efficiency. For example, the high-pressure pumps 112, 118 can use power recovered from the turbine 132.

To further convert the SCWG product gas 131 into a more H₂-rich gas and improve the H₂ yield, the SCWG product gas 131 can be further processed in the second reactor 108 for methane reforming, e.g., steam methane reforming. For example, methane steam reforming is a process to react CH₄ with steam (H₂O) under high temperatures and pressures in the presence of a reforming catalyst. The primary reaction of methane reforming forms carbon monoxide (CO) and H₂. In some implementations, the process can be further coupled with a water-gas shift (WGS) reaction with additional steam to convert the CO to form CO₂ and additional H₂. As illustrated in FIG. 1, a heater 134 can be used to heat the SCWG product gas 131 to a process temperature for methane reforming.

While conventional methane steam reforming is often performed at temperatures above 700° C., e.g., from about 700° C. to about 1000° C., in some implementations, a H₂-selective membrane reactor can be used for the second reactor 108, as illustrated in FIG. 1, to enable a lower temperature process. The use of a membrane reactor can facilitate in-situ separation of the produced H₂ from the reactor, shifting the reaction equilibrium toward higher CH₄ conversion and more H₂ production. For example, using the H₂-selective membrane reactor, the reforming step can be performed at a temperature from about 450° C. to about 650° C., e.g., from about 500° C. to about 650° C., from about 550° C. to about 650° C., from about 600° C. to about 650° C., from about 450° C. to about 600° C., from about 450° C. to about 550° C., from about 450° C. to about 500° C., or at about 550° C. In various implementations, the process pressure is from about 2 MPa to about 6 MPa, e.g., from about 3 MPa to about 6 MPa, from about 4 MPa to about 6 MPa, from about 5 MPa to about 6 MPa, from about 2 MPa to about 5 MPa, from about 2 MPa to about 4 MPa, from about 2 MPa to about 3 MPa, or at about 4 MPa.

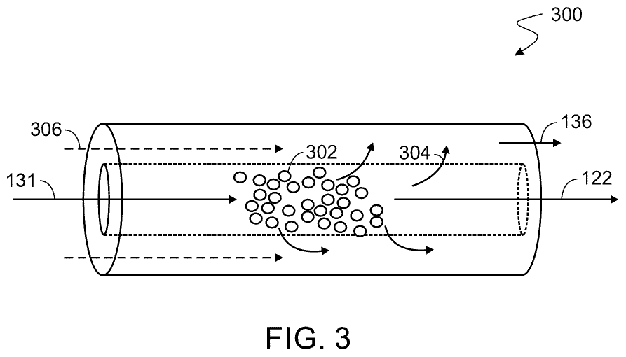

In various implementations, the second reactor 108 is a H₂-selective membrane tube 300 as illustrated in FIG. 3. This tube 300 can be characterized or labeled as cylindrical membranes or hollow membranes. The material of this membrane can be, for example, a palladium (Pd) or Pd alloy. The membrane can be a thin film of Pd alloy supported on a tubular porous substrate composed of a metal or metal oxide. Other materials suitable for the hydrogen-selective membrane tube 300 can include ceramic materials such as perovskite oxides. The membrane material can be selected to have a sufficient thermal stability at a reaction temperature, e.g., >550° C., and H₂ permeability and selectivity at this temperature. For example, a Pd alloy such as palladium-silver (Pd—Ag), palladium-gold (Pd—Au), and palladium-copper (Pd—Cu) can be used for high hydrogen flux and high purity, e.g., >99.99%.

As illustrated in FIG. 3, the SCWG product gas 131 can be introduced into the H₂-selective membrane tube 300 charged with a reforming catalyst 302. In various implementations, the reforming catalyst 302 includes a metal element such as Ni, Ru, Fe, and platinum (Pt). In some implementations, the catalytic component can be supported on a support material such as alumina or other oxide or nitride materials.

In FIG. 3, a permeate product stream 136, which is enriched with additional H₂ by the reforming, is obtained as a permeate from a permeate side of the H₂-selective membrane tube 300, while the retentate product stream 122 containing other reaction products such as CO₂ and H₂O is separately recovered. In some implementations, to further enhance the H₂ permeation from inside the H₂-selective membrane tube 300, a sweep gas 306, e.g., nitrogen (N₂) or steam, is flowed to the permeate side. Since it is practically difficult to attain zero H₂ partial pressure in the permeate side either, not all H₂ in the tube can be collected. Having the flow of the sweep gas 306 in the permeate side can reduce the H₂ partial pressure in the H₂-selective membrane tube 300, and thus enhance the separation.

In various implementations, the sweep gas 306 can be co-current or countercurrent with respect to the flow direction of the SCWG product gas 131. The merits of the two configurations, co-current and countercurrent, depend on the scale and the pressure in the retentate side.

In various implementations, the sweep gas 306 includes steam. The use of steam for the sweep gas 306 offer the advantage of a cost-effective, inert carrier gas to dilute the H₂ on the permeate side of the H₂-selective membrane tube 300. It can reduce the partial pressure of H₂ on the permeate side and thereby enhance the driving force for permeation. The steam can be readily condensed and separated from the product gas stream by a subsequent separation unit, which can be more economical and energy efficient compared to implementations with other sweep gases such as helium (He) or N₂.

Referring back to FIG. 1, in implementations where a H₂-selective membrane reactor is used for the second reactor 108, the permeate product stream 136 is a H₂-rich stream and the retentate product stream 122 is rich in CO₂ and H₂O. Further, in implementations where a heat exchanger is used for the preheater 120, the retentate product stream 122 can be sent to the preheater 120 to provide the heat for preheating the wastewater retentate 114. As a heat exchanger, the preheater 120 can cool down the retentate product stream 122. In some implementations, additional cooling of the retentate product stream 122 can be performed using a cooler 138. The CO₂ in the retentate product stream can be separated by a gas liquid separation unit 140 and the treated clean water can be recovered and recycled back.

The H₂ and the sweep gas component such as N₂ or H₂O can be obtained in the permeate product stream 136. In various implementations, the permeate product stream is cooled down using a cooler 142 and sent to a gas liquid separation unit 144 for H₂ separation.

In FIG. 1, the schematic of the wastewater treatment system 100 is simplified for illustration purpose, including its size and dimensions, relative positions of each reactor components, and the number of each component such as pump, cooler, and heat exchanger. For example, the wastewater treatment system 100 of FIG. 1 is drawn to have two high-pressure pumps 112, 118, but in various implementations, any number of such pumps can be used depending on the desired process conditions and need for adjustment at each stage of the process. Further, in some implementations, some of the heaters, coolers, heat exchangers and other components can be omitted.

Implementations described above referring to FIG. 1 allows the use of a H₂-selective membrane reactor for the second reactor 108 and a low temperature reforming, e.g., at about 550° C., which can be desired to maximize the H₂ yield from the wastewater treatment. The wastewater treatment system of this disclosure can also be designed and operated to produce a syngas (a mixture of H₂ and CO), for example, by performing the reforming at lower pressures and higher temperatures.

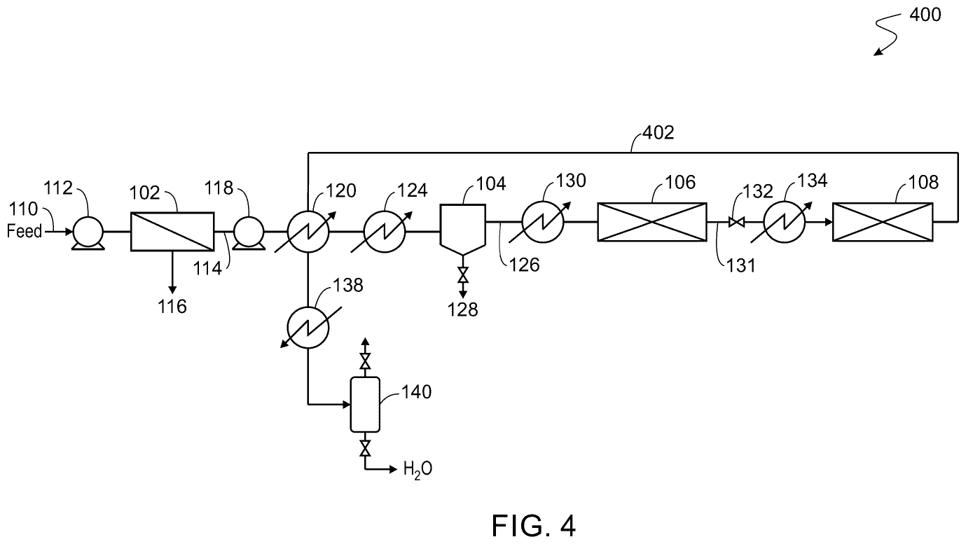

In FIG. 4, a wastewater treatment system 400 has an alternative configuration that is designed for syngas production from a wastewater. Various components of the wastewater treatment system 400 including a RO unit 102, a salt separator 104, a first reactor 106, and a second reactor 108 can be identical or similar to those already described above referring to FIG. 1, and thus will not be repeated.

In FIG. 4, similar to FIG. 1, the SCWG product gas 131 is further processed in the second reactor 108 for methane reforming. In various implementations, the second reactor 108 is a catalytic fixed bed reactor charged with a reforming catalyst, e.g., a Ni based heterogenous catalyst. In some implementations, the second reactor 108 is not a membrane reactor. In some implementations, the reactors and process are designed to suppress the WGS reaction and to produce a syngas. The pressure of the SCWG product gas 131 can be lowered to a process pressure for methane reforming. In some implementations, the process pressure is above 0.5 MPa, e.g., from about 0.5 MPa to about 1.0 MPa. Further, the SCWG product gas 131 can be heated to a process temperature above 800° C., e.g., from about 800° C. to about 1000° C., from about 850° C. to about 1000° C., from about 900° C. to about 1000° C., from about 950° C. to about 1000° C., from about 800° C. to about 950° C., from about 800° C. to about 900° C., or from about 800° C. to about 850° C. Operating the second reactor 108 under such conditions, the SCWG product gas 131 can be converted to a H₂-rich syngas product stream 402 containing CO, CO₂, and H₂O. Unlike the implementations with a membrane reactor as described previously, only a single product stream is obtained. The H₂-rich syngas product stream 402 can be sent to a preheater 120 to provide the heat for preheating the wastewater retentate 114. As a heat exchanger, the preheater 120 can cool down the H₂-rich syngas product stream 402. In some implementations, additional cooling of the H₂-rich syngas product stream 402 can be performed using a cooler 138. The syngas component (H₂ and CO) in the H₂-rich syngas product stream 402 can be separated by a gas liquid separation unit 140 and the treated clean water can be recovered and recycled back. In various implementations, the syngas can be further used as a raw material for production of valuable chemicals such as hydrocarbons, alcohols, and ammonia.

FIG. 5 is an example process flow diagram of methods of H₂ production using a step-wise wastewater treatment system of this disclosure. A process 500 starts with a step 502 of pressurizing a wastewater stream including organic and inorganic contaminants, e.g., to a pressure above 20 MPa, followed by a step 504 of heating the wastewater stream to a first temperature, e.g., a temperature from about 350° C. to about 400° C. At a step 506, the pressurized and heated wastewater stream is fed to a salt separator to separate the inorganic contaminants from the pressurized and heated wastewater stream and to generate a salt-free wastewater stream. At a step 508, the salt-free wastewater stream is heated to a second temperature, e.g., a temperature from about 400° C. to about 550° C. At a step 510, the salt-free wastewater stream is converted into a methane-containing gasification product under a sub- or supercritical condition using a first reactor. Here, the methane is formed from converting the organic contaminants. At a step 512, the methane-containing gasification product is reformed using a second reactor including a reforming catalyst to produce a product stream including H₂, CO₂, and water vapor. The process flow in FIG. 5 is for example only, and in various implementations, other additional pretreatment, e.g., reverse osmosis, and/or posttreatment steps, e.g., separating the H₂ from the product stream, can also be performed as described in the previous sections.

### EXAMPLES

Contaminant concentrations of two example wastewater feeds to be processed by a wastewater treatment system of this disclosure are summarized below in Tables 1-2. As shown in Table 1, a RO process can concentrate both organic and inorganic contaminants in a retentate stream. Further, as shown in Table 2, using a RO process, the rejection of 90% or higher can be obtained for most contaminant species. Accordingly, the wastewater treatment of this disclosure can benefit by incorporating a RO process as a pretreatment prior to salt separation and hydrothermal gasification.

TABLE 1
Organic and inorganic contaminant concentrations in
wastewater before and after reserve osmosis (RO).

| | | After RO | After RO |
|---|---|---|---|
| | Before RO | (permeate) | (retentate) |
| | (wt. %) | (wt. %) | (wt. %) |
| Organic | 3.32 | 0.13 | 6.5 |
| Inorganic salt | 1.01 | 0.1 | 1.9 |
| Water | 95.68 | 99.8 | 91.6 |

TABLE 2
Organic and inorganic contaminant concentrations in gas refinery
wastewater before and after reserve osmosis (RO).

| | Feed | | Permeate | Rejection |
|---|---|---|---|---|
| Total dissolved solids (TDS) | 210-1200 | | 5.1 | >98% |
| Salinity | 0.1-1.2% | | 0.01% | 85% |
| Conductivity | 280-2560 | | 11.1 | >98% |
| | microsec/cm | | microsec/cm | |
| Oil and grease (O&G) | 15-80 | mg/L | n.d. | >94% |
| Chemical oxygen demand | 19-140 | mg/L | n.d. | >94% |
| (COD) | | | | |
| Total organic carbon (TOC) | 6-22 | mg/L | 11 mg/L | 91% |
| Sulfate | 28-54 | mg/L | 4.1 mg/L | 91% |
| Chloride | 30-2000 | mg/L | 10 mg/L | 94% |
| Phosphate | <0.5-5 | mg/L | n.d. | >90% |

To demonstrate the capability of the wastewater treatment system of this disclosure, a step-wise wastewater treatment in accordance with an implementation was simulated using a commercial software Aspen Plus® v12. A Peng-Robinson-Boston-Mathias (PR-BM) property method was applied in the prediction of fluid properties. n-Octane was considered as oil compound and silicon oxide (SiO₂) as representative inorganic compound. A schematic of a simulated process is shown in FIG. 6. Stream properties are summarized in Table 3. In the present example, a wastewater containing 10 wt % hydrocarbon is treated in a first reactor 106 (a SCWG reactor) followed by a second reactor 108 (a steam methane reformer (SMR) membrane reactor) for hydrogen production. A process model has been developed for the overall process described above using octane as a representative feedstock, and is used to generate the overall material balance.

A 1000 kg/h waste organic feed as a wastewater stream 110 is pressurized through a high-pressure pump 112 to 250 bar (25 MPa) and preheated to 265° C. in a heat exchanger/preheater 120 where heat exchange takes place between a feed stream 114 and a retentate product stream 122 coming from the second reactor 108. The temperature of a preheated feed stream 123 is raised using a heater 124 to 380-420° C. for removal of inorganic component in a supercritical water salt separator 104. After separation of inorganic content, a salt-free wastewater 126 is further heated through an external heater 130 to 550° C. before feeding to the first reactor 106. The pressurized and hot stream 127 is fed to the first reactor 106 where temperature of 550° C. and pressure of 250 bar (25 MPa) is maintained. Organics present in aqueous feed is converted to products containing H₂ and CH₄ in the first reactor 106. Conversion of organics to gaseous product leads to formation of 23.9 mole % H₂, 53.4 mole % CH₄, 22.3 mole % CO₂ and 0.4 mole % CO on a moisture free basis. The SCWG product is further processed in the second reactor 108 (SMR membrane reactor) that contains a tubular hydrogen separation palladium alloy membrane. The pressure of a SCWG product gas 131 is reduced to 40 bar (4 MPa) (a stream 133) and heated to maintain the desired pressure and temperature condition of membrane reactor (stream 135). N₂ or steam can be used as a sweep stream to the co-current/counter current mode of operation for further enhancement CH₄ conversion. CO₂ and water are obtained as a retentate product stream 122 in the membrane reformer. H₂ and water are obtained as a permeate product stream 136 which are further cooled down using a cooler 142 and separated using a gas liquid separation unit 144 to obtain H₂ product and an effluent 139. The retentate product stream 122 contains treated water and CO₂. After cooling down in the heat exchanger/preheater 120 and a cooler 138 (stream 143), gas liquid separation is performed using a gas liquid separation unit 140, and a clean water stream 145 is recycled back to plant and CO₂ is obtained as a co-product 147.

TABLE 3
Stream properties simulated by Aspen Plus ® for wastewater treatment.

| Stream | Pressure | Temperature | H₂O | Organics | Inorganics | CH₄ | CO | CO₂ | H₂ |
|---|---|---|---|---|---|---|---|---|---|
| (no.) | (MPa) | (° C.) | (kg/h) | (kg/h) | (kg/h) | (kg/h) | (kg/h) | (kg/h) | (kg/h) |
| 110 | 0.1 | 25 | 890 | 100 | 10 | 0 | 0 | 0 | 0 |
| 123 | 25 | 137 | 890 | 100 | 10 | 0 | 0 | 0 | 0 |
| 125 | 25 | 400 | 890 | 100 | 10 | 0 | 0 | 0 | 0 |
| 126 | 25 | 400 | 890 | 0 | 0 | 0 | 0 | 0 | 0 |
| 127 | 25 | 550 | 890 | 0 | 0 | 0 | 0 | 0 | 0 |
| 128 | 0.1 | 25 | 0 | — | 10 | 0 | 0 | 0 | 0 |
| 131 | 25 | 550 | 815 | 0 | 0 | 78.8 | 0.99 | 90.5 | 4.43 |
| 133 | 25 | 475 | 815 | 0 | 0 | 78.8 | 0.99 | 90.5 | 4.43 |
| 135 | 25 | 550 | 815 | 0 | 0 | 78.8 | 0.99 | 90.5 | 4.43 |
| H₂ Prod. | 0.15 | 5 | 0 | 0 | 0 | 0 | 0 | 0 | 31.0 |
| (after | | | | | | | | | |
| 144) | | | | | | | | | |
| 122 | 4 | 550 | 642 | 0 | 0 | 0 | 2.24 | 301 | 0 |
| 141 | 4 | 440 | 642 | 0 | 0 | 0 | 2.24 | 301 | 0 |
| 143 | 4 | 40 | 642 | 0 | 0 | 0 | 2.24 | 301 | 0 |
| 145 | 0.15 | 5 | 641.5 | 0 | 0 | 0 | 0 | 0.1 | 0 |
| 147 | 0.15 | 5 | 0.5 | 0 | 0 | 1.3 | 2.25 | 300.9 | 0 |

### Implementations

An implementation described in this disclosure provides a method of producing hydrogen (H₂) and clean water from a wastewater stream. The method includes pressurizing a wastewater stream including organic and inorganic contaminants, and heating the wastewater stream to a first temperature. The method includes feeding the pressurized and heated wastewater stream to a salt separator to separate the inorganic contaminants from the pressurized and heated wastewater stream, generating a salt-free wastewater stream. The method further includes heating the salt-free wastewater stream to a second temperature, and converting the salt-free wastewater stream at the second temperature into a methane-containing gasification product under a sub- or supercritical condition using a first reactor, the methane being formed from the organic contaminants. The method further includes reforming the methane-containing gasification product using a second reactor including a reforming catalyst to produce a product stream including H₂, carbon dioxide (CO₂), and water vapor.

In an aspect, the wastewater stream is pressurized to a pressure above 20 MPa.

In an aspect, combinable with any other aspect, the first temperature is 350° C. or higher.

In an aspect, combinable with any other aspect, the method further includes, prior to feeding the pressurized and heated wastewater stream to the salt separator, concentrating the organic and inorganic contaminants in the wastewater stream by reserve osmosis

In an aspect, combinable with any other aspect, the salt separator includes a reverse flow vessel, and at least a portion of the pressurized and heated wastewater stream is processed under a supercritical condition in the reverse flow vessel.

In an aspect, combinable with any other aspect, the second temperature is from 400° C. to 550° C.

In an aspect, combinable with any other aspect, the second reactor is a H₂-selective membrane reactor that forms a permeate including the H₂ and a retentate including the CO₂ and water vapor.

In an aspect, combinable with any other aspect, the methane-containing gasification product is reformed at a pressure from 3.5 MPa to 4.5 MPa and a temperature from 500° C. to 600° C.

In an aspect, combinable with any other aspect, the product stream includes carbon monoxide (CO).

In an aspect, the methane-containing gasification product is reformed at a pressure above 0.5 MPa and a temperature above 800° C.

In an aspect, combinable with any other aspect, the method further includes: recovering heat from the second reactor during reforming the methane-containing gasification product; and using the recovered heat for the step of heating the salt-free wastewater stream.

An implementation described in this disclosure provides a method of producing H₂ and clean water from a wastewater stream. The method includes feeding a wastewater stream to a reserve osmosis (RO) system, the wastewater stream including organic and inorganic contaminants and originating from an oil refinery plant. The method further includes using the RO system, concentrating the organic and inorganic contaminants in the wastewater stream, forming a concentrated retentate stream. The method further includes pressurizing the concentrated retentate stream to a pressure above 20 MPa. The method further includes heating the concentrated retentate stream to a temperature above 350° C. The method further includes feeding the pressurized and heated concentrated retentate stream to a salt separator to separate the inorganic contaminants from the pressurized and heated concentrated retentate stream, generating a salt-free wastewater stream. The method further includes heating the salt-free wastewater stream to a temperature above 400° C. The method further includes converting the salt-free wastewater stream into a methane-containing gasification product under a supercritical condition using a first reactor. The method further includes reforming the methane-containing gasification product using a second reactor including a reforming catalyst to produce a product stream including H₂, carbon dioxide (CO₂), and water vapor.

In an aspect, the organic contaminants include an aromatic hydrocarbon, and the inorganic contaminants include sodium, potassium, magnesium, chlorine, sulfate, carbonate, silicate, or borate.

In an aspect, the salt-free wastewater stream is converted in the absence of an oxidant in the first reactor.

An implementation described in this disclosure provides a wastewater treatment system including a salt separator to separate inorganic contaminants from a wastewater steam including organic contaminants and the inorganic contaminants. The wastewater treatment system further includes a first reactor, fluidically connected and downstream to the salt separator, to perform hydrothermal gasification of the wastewater stream and product a methane-containing stream. The wastewater treatment system further includes a second reactor, fluidically connected and downstream to the first reactor, to perform a reforming reaction of the methane-containing stream under a supercritical condition and produce a product stream including hydrogen (H₂), carbon dioxide (CO₂), and water vapor The wastewater treatment system further includes a gas liquid separation unit, fluidically connected and downstream to the second reactor, to separate the CO₂ and the water vapor. The wastewater treatment system further includes a computer processor including a non-transitory computer readable medium storing instruction to feed the wastewater stream to the salt separator under a sub- or supercritical condition, feed the wastewater stream to the first reactor under a sub- or supercritical condition, and separate the H₂ from the product stream.

In an aspect, the wastewater treatment system further includes a reverse osmosis unit, fluidically connected and upstream to the salt separator, to concentrate the organic contaminants and the inorganic contaminants in the wastewater stream.

In an aspect, combinable with any other aspect, the second reactor includes a H₂-selective membrane reactor that forms a permeate including the H₂ and a retentate including the CO₂ and water vapor.

In an aspect, combinable with any other aspect, a sweep gas is flowed in a permeate side of the H₂-selective membrane reactor for H₂ separation, the wastewater treatment system further including another gas liquid separation unit, fluidically connected and downstream to the H₂-selective membrane reactor, to separate the H₂ from the sweep gas.

In an aspect, combinable with any other aspect, the wastewater treatment system further includes a heat exchanger to recover heat from the second reactor and use the recovered heat to heat the wastewater stream before feeding the wastewater stream to the salt separator.

In an aspect, combinable with any other aspect, the salt separator includes a reverse flow vessel having at least one inlet and two outlets, one of the outlets draining a brine effluent while the other of the outlets, fluidically connected to the first reactor, ejecting a salt-free wastewater stream including the organic contaminants.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of producing hydrogen (H₂) and clean water from a wastewater stream, the method comprising:
pressurizing a wastewater stream comprising organic and inorganic contaminants;
heating the wastewater stream to a first temperature;
feeding the pressurized and heated wastewater stream to a salt separator to separate the inorganic contaminants from the pressurized and heated wastewater stream, generating a salt-free wastewater stream;
heating the salt-free wastewater stream to a second temperature;
converting the salt-free wastewater stream at the second temperature into a methane-containing gasification product under a sub- or supercritical condition using a first reactor, the methane being formed from the organic contaminants; and
reforming the methane-containing gasification product using a second reactor comprising a reforming catalyst to produce a product stream comprising H₂, carbon dioxide (CO₂), and water vapor.

2. The method of claim 1, wherein the wastewater stream is pressurized to a pressure above 20 MPa.

3. The method of claim 1, wherein the first temperature is 350° C. or higher.

4. The method of claim 1, further comprising, prior to feeding the pressurized and heated wastewater stream to the salt separator, concentrating the organic and inorganic contaminants in the wastewater stream by reserve osmosis.

5. The method of claim 1, wherein the salt separator comprises a reverse flow vessel, and at least a portion of the pressurized and heated wastewater stream is processed under a supercritical condition in the reverse flow vessel.

6. The method of claim 1, wherein the second temperature is from 400° C. to 550° C.

7. The method of claim 1, wherein the second reactor is a H₂-selective membrane reactor that forms a permeate comprising the H₂ and a retentate comprising the CO₂ and water vapor.

8. The method of claim 7, wherein the methane-containing gasification product is reformed at a pressure from 3.5 MPa to 4.5 MPa and a temperature from 500° C. to 600° C.

9. The method of claim 1, wherein the product stream comprises carbon monoxide (CO).

10. The method of claim 9, wherein the methane-containing gasification product is reformed at a pressure above 0.5 MPa and a temperature above 800° C.

11. The method of claim 1, further comprising:
recovering heat from the second reactor during reforming the methane-containing gasification product; and
using the recovered heat for the step of heating the salt-free wastewater stream.

12. A method of producing hydrogen (H₂) and clean water from a wastewater stream, the method comprising:
feeding a wastewater stream to a reserve osmosis (RO) system, the wastewater stream comprising organic and inorganic contaminants and originating from an oil refinery plant;
using the RO system, concentrating the organic and inorganic contaminants in the wastewater stream, forming a concentrated retentate stream;
pressurizing the concentrated retentate stream to a pressure above 20 MPa;
heating the concentrated retentate stream to a temperature above 350° C.;
feeding the pressurized and heated concentrated retentate stream to a salt separator to separate the inorganic contaminants from the pressurized and heated concentrated retentate stream, generating a salt-free wastewater stream;
heating the salt-free wastewater stream to a temperature above 400° C.;
converting the salt-free wastewater stream into a methane-containing gasification product under a supercritical condition using a first reactor; and
reforming the methane-containing gasification product using a second reactor comprising a reforming catalyst to produce a product stream comprising H₂, carbon dioxide (CO₂), and water vapor.

13. The method of claim 12, wherein the organic contaminants comprise an aromatic hydrocarbon, and the inorganic contaminants comprise sodium, potassium, magnesium, chlorine, sulfate, carbonate, silicate, or borate.

14. The method of claim 12, wherein the salt-free wastewater stream is converted in the absence of an oxidant in the first reactor.

15. A wastewater treatment system comprising:
a salt separator to separate inorganic contaminants from a wastewater steam comprising organic contaminants and the inorganic contaminants;
a first reactor, fluidically connected and downstream to the salt separator, to perform hydrothermal gasification of the wastewater stream and product a methane-containing stream;
a second reactor, fluidically connected and downstream to the first reactor, to perform a reforming reaction of the methane-containing stream under a supercritical condition and produce a product stream comprising hydrogen (H₂), carbon dioxide (CO₂), and water vapor;
a gas liquid separation unit, fluidically connected and downstream to the second reactor, to separate the CO₂ and the water vapor; and
a computer processor comprising a non-transitory computer readable medium storing instruction to
feed the wastewater stream to the salt separator under a sub- or supercritical condition,
feed the wastewater stream to the first reactor under a sub- or supercritical condition, and
separate the H₂ from the product stream.

16. The wastewater treatment system of claim 15, further comprising a reverse osmosis unit, fluidically connected and upstream to the salt separator, to concentrate the organic contaminants and the inorganic contaminants in the wastewater stream.

17. The wastewater treatment system of claim 15, wherein the second reactor comprises a H₂-selective membrane reactor that forms a permeate comprising the H₂ and a retentate comprising the CO₂ and water vapor.

18. The wastewater treatment system of claim 17, wherein a sweep gas is flowed in a permeate side of the H₂-selective membrane reactor for H₂ separation, the wastewater treatment system further comprising another gas liquid separation unit, fluidically connected and downstream to the H₂-selective membrane reactor, to separate the H₂ from the sweep gas.

19. The wastewater treatment system of claim 15, further comprising a heat exchanger to recover heat from the second reactor and use the recovered heat to heat the wastewater stream before feeding the wastewater stream to the salt separator.

20. The wastewater treatment system of claim 15, wherein the salt separator comprises a reverse flow vessel having at least one inlet and two outlets, one of the outlets draining a brine effluent while the other of the outlets, fluidically connected to the first reactor, ejecting a salt-free wastewater stream comprising the organic contaminants.
